(19) United States
(12) Patent Application Publication
(10) Pub. No.: US 2008/0162576 A1
(43) Pub. Date: Jul. 3, 2008

(54) COMMERCIAL PRODUCT INFORMATION MANAGEMENT DEVICE

(75) Inventor: Tomoichiro HAYASHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/961,073

(22) Filed: Dec. 20, 2007

(30) Foreign Application Priority Data
Dec. 27, 2006 (JP) JP2006-353223

(51) Int. Cl. G06F 17/30

(52) U.S. Cl. 707/104.1; 707/E17.044

(57) ABSTRACT

To enable commercial product information to be properly managed and information on a person inputting the commercial product information to be used together with the commercial product information. A computer executes receiving commercial product information inputted by an operation of an operator and operator information specifying the operator, storing a storage unit with identifying information in the way of being associated with the commercial product information and the operator information, and, when receiving the identifying information on the occasion of a query from a user and when transmitting the associated commercial product information and receiving a signal purporting a purchase of the commercial product associated with the identifying information from the user, getting purchase information of the commercial product stored in the way of being associated with the operator information.

This application claims the benefit of Japanese Patent Application No. 2006-353223 filed on Dec. 27, 2006 in the Japanese Patent Office, the disclosure of which is herein incorporated in its entirety by reference.

### BACKGROUND OF THE INVENTION

The present invention relates to a technology of managing commercial product information on the occasion of selling commercial products via a network.

There is wide spread of so-called net shopping, wherein consumers (users) access Web sites (mail-order sales sites) via a network such as the Internet, and purchases commercial products.

For example, there is a selling system called BTO (Built To Order) at the sales site of personal computers (PCs), wherein the user gives an order of a self-configured (self-parts-assembled) PC by designating necessary parts, while a seller builds up the PC according to the order and thus sells the PC.

The BTO eliminates a necessity of preparing models having a variety of specifications beforehand, and restrains the cost as well as enabling needs of the user to be adequately fulfilled.

Further, the following Patent documents 1 to 3 disclose a technology as the prior art related to the invention of the present application.

[Patent document 1]

Japanese Patent Application Laid-Open Publication No. 2002-109378

[Patent document 2]

Japanese Patent Application Laid-Open Publication No. 2005-084756

[Patent document 3]

Japanese Patent Application Laid-Open Publication No. 2002-024639

### SUMMARY OF THE INVENTION

The BTO requires the users to have a considerable amount of knowledge about the commercial products in order to give the order without any contradiction by designating the parts one by one, and is therefore a hard-to-utilize system to beginners having a small amount of knowledge about the commercial products.

Thus, when the beginner is to purchase the commercial product requiring the knowledge about this commercial product, it is a general practice that he or she buys it while hearing a description of the commercial product from an acquaintance and a person in charge at the shop or by phone.

However, some consumers exist, who do not purchase at the very site but will buy the commercial product another day after careful consideration.

Thus, if the description receiving timing is different from the purchase timing of the commercial product, a problem is that the person who explained the commercial product is not evaluated.

Further, if the consumer (a first user) introduces the commercial product to another consumer (a second user), this introduction is not evaluated.

Such being the case, the present invention provides a technology capable of properly managing the commercial product information, and making information about a person who inputs the commercial product information, usable together with the commercial product information.

The present invention adopts the following configurations in order to solve the problems.

Namely, according to the present invention, a commercial product information management device comprises:

a commercial product input module receiving commercial product information inputted by an operation of a first user and first user information specifying the first user;

a commercial product registration module storing a storage unit with commercial product identifying information and incentive information in the way of being associated with the commercial product information and the first user information; and

a response module transmitting, when receiving the identifying information on the occasion of a query from a second user, the associated commercial product information and the associated incentive information.

The commercial product registration module may generate the incentive information of the first user and the incentive information of a second user, and may get these items of information stored.

The commercial product registration module, when the commercial product input module receives incentive designation information from the first user, may generate the incentive information of the first user and the incentive information of the second user on the basis of the designation information.

The designation information may also be information for designating a ratio of the incentive information of the first user to the incentive information of the second user.

Further, according to the present invention, a commercial product information management method by which a computer executes:

receiving commercial product information inputted by an operation of a first user as an operator and first user information specifying the first user;

storing a storage unit with commercial product identifying information and incentive information in the way of being associated with the commercial product information and the first user information; and

transmitting, when receiving the identifying information on the occasion of a query from a second user, the associated commercial product information and the associated incentive information.

In the commercial product information management method, the incentive information of the first user and the incentive information of a second user may be generated and stored.

In the commercial product information management method, when receiving incentive designation information from the first user, the incentive information of the first user and the incentive information of the second user may be generated based on the designation information.

The designation information may also be information for designating a ratio of the incentive information of the first user to the incentive information of the second user.

Further, the present invention may also be a commercial product information management program for making a computer execute the commercial product information management method. Still further, the present invention may also be a readable-by-computer recording medium recorded with this commercial product information management program. The computer is made to read and execute the program on this recording medium, thereby enabling the functions thereof to be provided.

Herein, the readable-by-computer recording medium connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc are given as the recording mediums fixed within the computer.

According to the present invention, it is feasible to provide the technology capable of properly managing the commercial product information, and making the information about the person who inputs the commercial product information, usable together with the commercial product information.

### BRIEF DESCRIPTION OF THE DRAWINGS

FIG. 1 is an explanatory view of a WEB shopping system.

FIG. 2 is a diagram of an outline of the WEB shopping system.

FIG. 3 is an explanatory flowchart of a commercial product information management method.

FIG. 4 is a diagram showing an example of an input screen.

FIG. 5 is an explanatory flowchart of the commercial product information management method.

FIG. 6 is an explanatory diagram of items of information stored in a storage unit.

FIG. 7 is an explanatory view of the WEB shopping system.

FIG. 8 is a diagram of an outline of the WEB shopping system.

FIG. 9 is an explanatory flowchart of the commercial product information management method.

FIG. 10 is an explanatory flowchart of the commercial product information management method.

FIG. 11 is an explanatory diagram of items of information stored in the storage unit.

### DETAILED DESCRIPTION OF THE PREFERRED EMBODIMENT

### First Embodiment

a best mode for carrying out the present invention will hereinafter be described with reference to the drawings. Configurations in the following embodiments are exemplifications, and the present invention is not limited to the configurations in the embodiments.

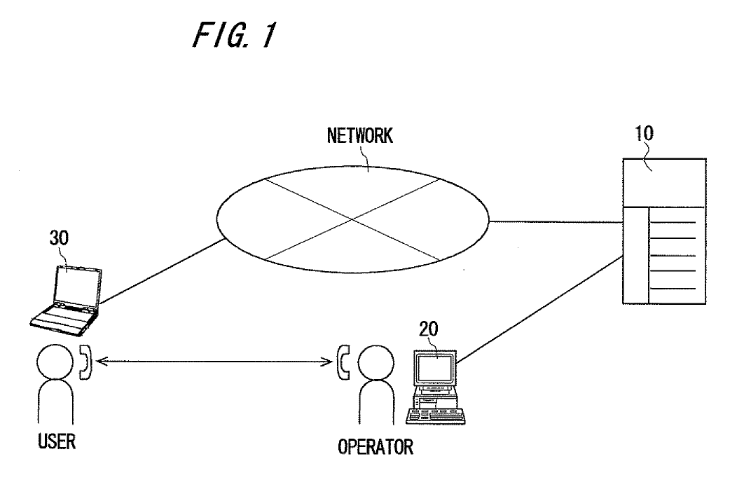

FIG. 1 is a view of an outline of a WEB shopping system including a commercial product information management device according to the present invention.

A WEB shopping system 10 in the present example provides a Web page for a BTO of a computer, and also retains commercial product information inputted from an operator terminal 20 and provides the commercial product information in response to a request given from a user terminal 30.

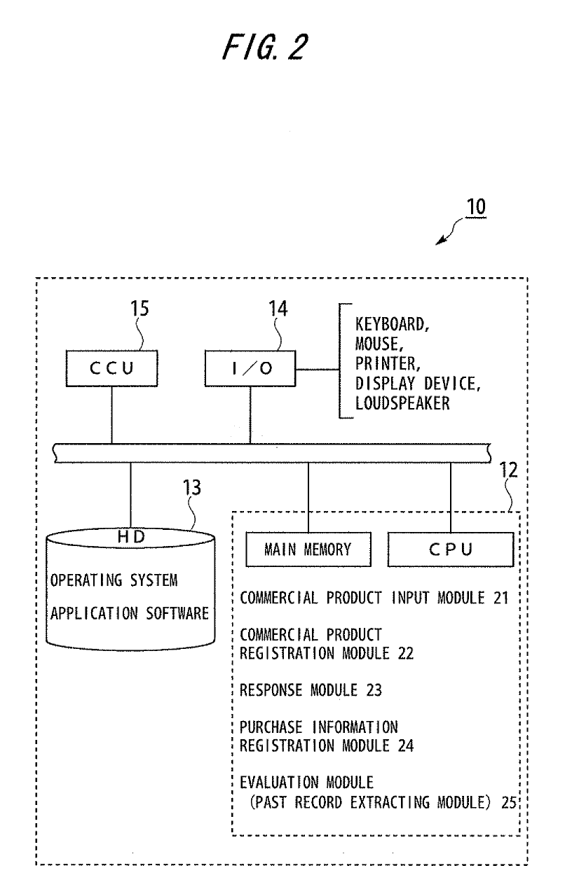

The WEB shopping system 10 is a general-purpose computer including, as illustrated in FIG. 2, an arithmetic processing unit 12 constructed of a CPU (Central Processing Unit), a main memory, etc, a storage unit (hard disk) 13 stored with data and software for an arithmetic process, an input/output port 14, a communication control unit (CCU) 15, etc.

Input devices such as a keyboard, a mouse and a CD-ROM drive and output devices such as a display device and a printer, are properly connected to the I/O port 14.

The CCU 15 controls communications with other computers via a network.

The storage unit 13 is preinstalled with an operating system (OS) and application software (commercial product information management program).

The arithmetic processing unit 12 properly reads the OS and the application program from the storage unit 13 and executes the OS and the application program, and arithmetically processes pieces of information inputted from the I/O port 14 and the CCU 15 and the information read from the storage unit 13, thereby functioning also as a commercial product input module 21, a commercial product registration module 22, a response module 23, a purchase information registration module 24 and an evaluation module (past record extracting module) 25.

The commercial product input module 21 receives the commercial product inputted by an operator's manipulation, incentive information and operator information representing the operator.

The commercial product registration module 22 stores identifying information in the storage unit 13 in a way that associates the identifying information with the commercial product information, the incentive information and the operator information.

The response module 23, when receiving the identifying information on the occasion of a query from a user, searches the storage unit 13 for the commercial product information matching with the query and transmits this commercial product information.

The purchase information registration module 24, when receiving a signal purporting a purchase of a commercial product associated with the identifying information from the user, stores the commercial product purchase information in the storage unit 13 in a way that associates the purchase information with the operator information.

The evaluation module 25 extracts the purchase information associated with the operator information from the storage unit 13 on an operator-by-operator basis, and evaluates the operator from takings (revenue), a sales count, a commercial product information providing count, etc of the operator.

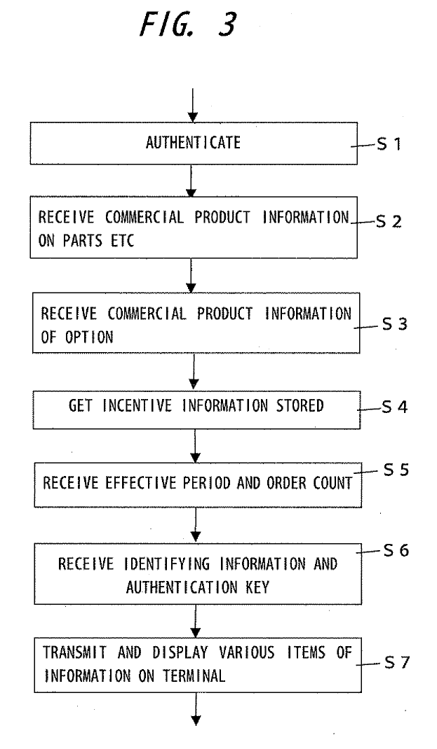

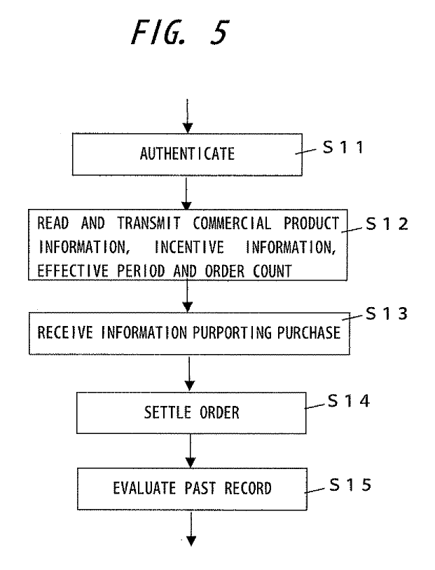

A commercial product information management method executed based on the application software by the WEB shopping system 10 including these components, will hereinafter be described with reference to FIGS. 3 and 5.

To start with, if requested by the user (the WEB user) to explain the commercial product on the phone, the operator accesses the WEB shopping system 10. The WEB shopping system 10 receiving the access prompts the operator to input authentication information (an operator ID and a password) and, if the authentication information inputted by the operator proves valid after referring to the information registered beforehand in the storage unit 13, authenticates the operator (step 1, which will hereinafter be abbreviated to such as S1)

The operator hears needs of the user, then selects required parts by operating the terminal 20, and inputs the information (the commercial product information) representing the required parts to the WEB shopping system 10 via the network. In the WEB shopping system 10, when receiving the input of the information through the commercial product input module 21, the commercial product registration module 22 stores the commercial product information in the storage unit 13 in a way that associates this commercial product information with the operator information (S2).

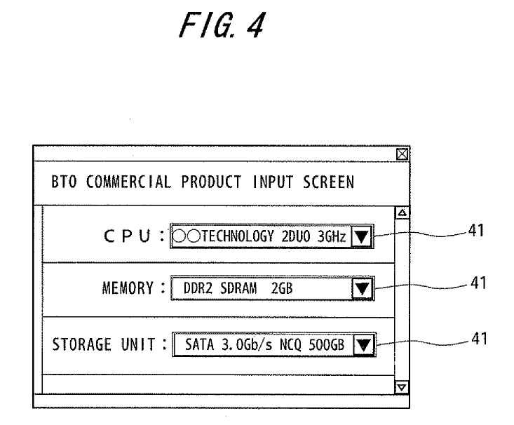

FIG. 4 illustrates an example of an input screen provided by the WEB shopping system 10 and displayed on the operator terminal 20.

The input screen is described as an HTML (HyperText Markup Language) file (WEB page), wherein the operator displays the input screen through a WEB Browser of the terminal, then inputs the parts in respective input boxes 41, and transmits this page to the WEB shopping system 10.

Similarly, in the WEB shopping system 10, when receiving the commercial product information representing options of a printer, an external storage, etc with the commercial product input module 21, the commercial product registration module 22 stores these items of commercial product information in the storage unit 13 (S3).

Further, the commercial product registration module 22 stores the storage-unit 13 with incentive information showing a special privilege in the case of purchasing the commercial product (S4). The incentive information may be inputted by the operator and may also be determined based on the commercial product information by the commercial product registration module 22. For instance, such applied conditions are stored as gaining a 10% discount if equal to larger than 100,000 yen, doubling a memory capacity if purchased during a campaign period and a 10,000-yen discount if purchasing a monitor and a main body simultaneously, and an incentive, having conditions matching with a product item, a price, a date (on which the commercial product information was inputted), etc of the commercial product information, is thereby determined.

Moreover, the storage means 13 gets stored with an effective period showing a period for which the commercial product can be ordered, and with an order count representing an upper limit count with which the commercial product can be ordered (S5).

Then, the commercial product registration module 22 stores the storage unit 13 with the identifying information for identifying the information and an authentication key in the way of being associated with the commercial product information, the incentive information, the effective period and the order count (S6).

Further, the response module 23 transmits, as a result of the registration, the identifying information, the authentication key, the commercial product information, the incentive information, the effective period and the order count to the terminal 20 of the operator, and displays them (S7)

The operator notifies the user of the identifying information and the authentication key by phone and by mail. On the other hand, the user notified of the identifying information, on the occasion of purchasing the commercial product, accesses the WEB shopping system 10 and transmits the authentication information (the identifying information and the authentication key) to the WEB shopping system 10 by operating the user terminal 30. The WEB shopping system 10 receiving the authentication information, as illustrated in FIG. 5, refers to the information registered beforehand and, if valid, authenticates the user (S11).

The WEB shopping system 10, if the user is authenticated, reads, from the storage unit 13, the commercial product, the incentive information, the effective period and the order count, which are associated with the identifying information in the authentication information, and transmits these items of information as a WEB page taking a predetermined format to the terminal 30 (S12). The WEB page is the same as in FIG. 4 and enables the parts and the options to be selected (modified) in the respective input boxes.

When the user selects an order button on the page, the user terminal 30 transmits, together with the information purporting the purchase, the identifying information and the commercial product information to the WEB shopping system 10 (S13). With these items of information, items of information necessary for the purchase such as a name and an address of the orderer and a payment method, may also be transmitted.

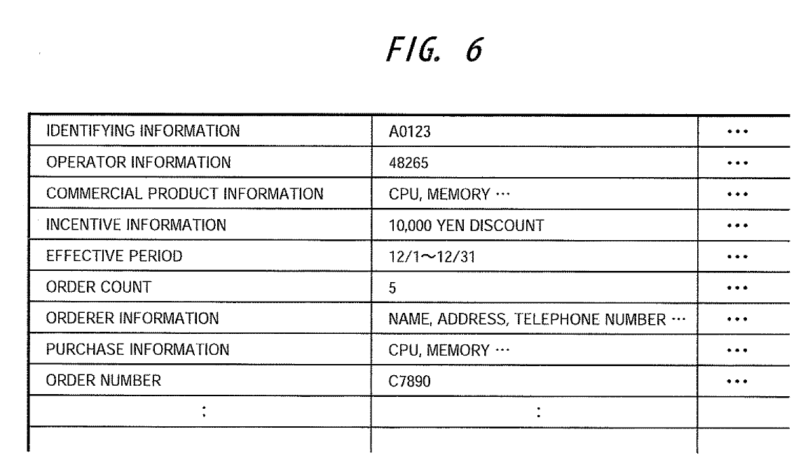

In the WEB shopping system 10, when receiving the information purporting the purchase, the purchase information registration module 24 stores the storage-unit with the purchase information such as the commercial product information, the price (revenue) of the commercial product and the incentive information in the way of associating the purchase information with the operator information, and thus settles the order (S14). FIG. 6 is an explanatory diagram of the information stored in the storage unit 13.

Then, the evaluation module 25 extracts the purchase information associated with the operator information on the operator-by-operator basis, and evaluates each individual operator from the takings, the sales count, the commercial product information providing count, etc of the operator (S5).

Thus, according to the first embodiment, the commercial product information can be properly managed, and it is therefore feasible for the user to easily invoke an operator-suggested combination of commercial products on the basis of the identifying information.

Further, even when the user gives the order another day, the operator associated with the identifying information can be evaluated. At this time, the incentive information is also associated with the identifying information, and hence it follows that the user obtains the identifying information in order to acquire the incentive, whereby the operator can be evaluated with high accuracy. Moreover, the incentive-attached scheme can refrain the suggested combination of commercial products from being purchased at other sites and shops.

Moreover, the effective period can be set up, whereby a sense of purchase can be stimulated.

Infinite spread of the incentives can be prevented by setting up the effective count. Further, the sale count can also be managed.

### Second Embodiment

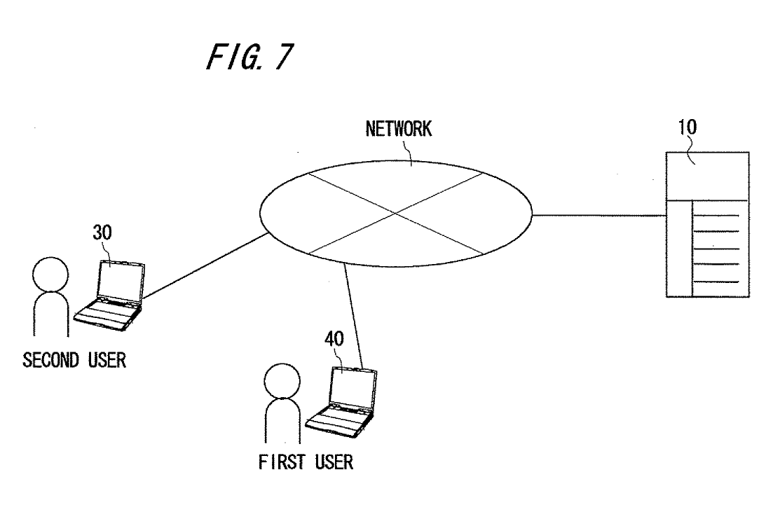

FIG. 7 is a view of an outline of the WEB shopping system including the commercial product information management device according to the present invention.

The WEB shopping system 10 in the present example retains the commercial product information inputted from a terminal 40 of a first WEB user (first-user), and provides the commercial product information in response to a request given from a terminal 30 of a second WEB user (second user).

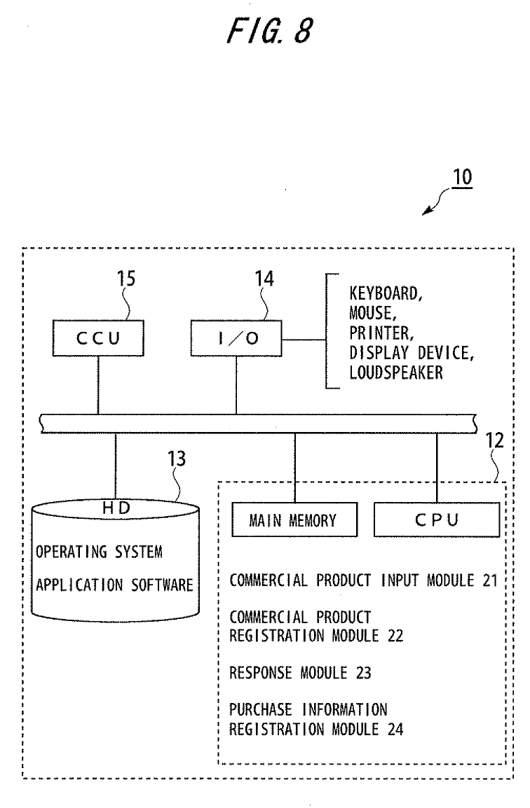

The WEB shopping system 10 is the general-purpose computer including, as illustrated in FIG. 8, the arithmetic processing unit 12 constructed of the CPU (Central Processing Unit), the main memory, etc, the storage unit (hard disk) 13 stored with the data and the software for the arithmetic process, the input/output port 14, the communication control unit (CCU) 15, etc.

The input devices such as the keyboard, the mouse and the CD-ROM drive and the output devices such as the display device and the printer, are properly connected to the I/O port 14.

The CCU 15 controls the communications with other computers via the network.

The storage unit 13 is preinstalled with the operating system (OS) and the application software (commercial product information management program).

The arithmetic processing unit 12 properly reads the OS and the application program from the storage unit 13 and executes the OS and the application program, and arithmetically processes pieces of information inputted from the I/O port 14 and the CCU 15 and the information read from the storage unit 13, thereby functioning also as the commercial product input module 21, the commercial product registration module 22, the response module 23, the purchase information registration module 24 and the evaluation module (past record extracting module) 25.

The commercial product input module 21 receives the commercial product information inputted by the first user's operation, incentive designation information and first user information specifying the first user. The designation information may designate goods for sales promotion and articles for options, and may also designate a discount rate and an amount of money for cash-back.

The commercial product registration module 22 stores the storage unit 13 with the identifying information in the way of being associated with the commercial product information, the incentive information and the first user information. Here at, the commercial product registration module 22 generates, at a rate based on the designation information, the incentive information for the first user and the incentive information for the second user, and gets these pieces of incentive information stored. For instance, the incentives may be allocated based on the designation information such as giving 25% to the first user and 75% to the second user or 0% to the first user and 100% to the second user with respect to the cash-back, points, etc.

The response module 23, when receiving the identifying information on the occasion of a query from the second user, searches the storage unit 13 for the associated commercial product information, and sends this commercial product information to the inquirer.

The purchase information registration module 24, when receiving a signal purporting a purchase of the commercial product associated with the identifying information from the second user, stores the purchase information of the commercial product in the storage unit 13 in the way of being associated with the first user information.

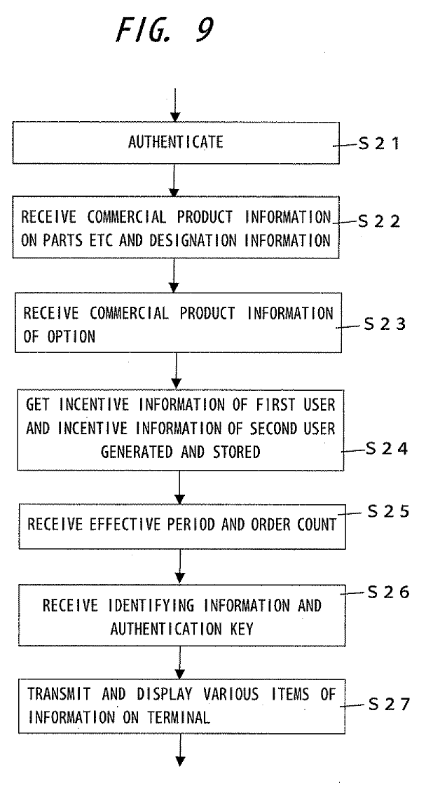

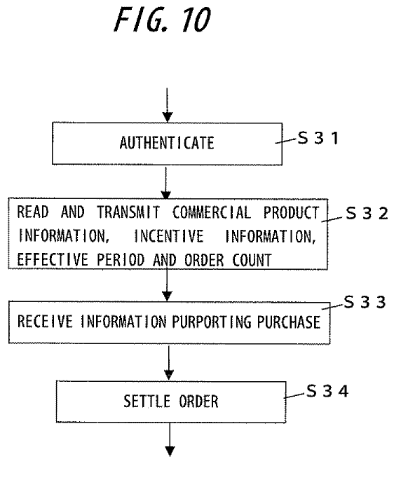

A commercial product information management method executed based on the application software by the WEB shopping system 10 including these components, will hereinafter be described with reference to FIGS. 9 and 10.

To start with, the first user accesses the WEB shopping system 10. The WEB shopping system 10 receiving the access prompts the first user to input authentication information (an ID and a password of the first user) and, if the authentication information inputted by the first user proves valid after referring to the information registered before hand in the storage unit 13, authenticates the first user (step 21, which will hereinafter be abbreviated to such as S21).

The first user, in accordance with needs of the second user, selects required parts by operating the terminal 40, and inputs the information (the commercial product information) representing the required parts and the incentive designation information to the WEB shopping system 10 via the network. In the WEB shopping system 10, when receiving the input of the information through the commercial product input module 21, the commercial product registration module 22 stores the commercial product information in the storage unit 13 in a way that associates this commercial product information with the first user information (S22).

FIG. 4 illustrates the example of the input screen provided by the WEB shopping system 10 and displayed on the first user terminal 40.

The input screen is described as the HTML (HyperText Markup Language) file (WEB page), wherein the first user displays the input screen through the WEB Browser of the terminal, then inputs the parts in respective input boxes 41, and transmits this page to the WEB shopping system 10.

Similarly, in the WEB shopping system 10, when receiving the commercial product information representing options of the printer, the external storage, etc with the commercial product input module 21, the commercial product registration module 22 stores these items of commercial product information in the storage unit 13 (S23).

Further, the commercial product registration module 22 stores the storage unit 13 with the incentive information showing the special privilege in the case of purchasing the commercial product (S24). The incentive information may be determined based on the commercial product information by the commercial product registration module 22. For example, such applied conditions are stored as giving points for 10% if equal to larger than 100,000 yen, doubling the memory capacity if purchased during the campaign period and 10,000-yen cash-back if purchasing the monitor and the main body simultaneously, and the incentive, having conditions matching with a product item, a price, a date (on which the commercial product information was inputted), etc of the commercial product information, is thereby determined. Herein, the commercial product registration module 22 generates the incentive information for the first user and the incentive information for the second user on the basis of the designation information inputted by the first user, and gets these items of information stored.

Moreover, the storage means 13 gets stored with the effective period showing the period for which the commercial product can be ordered, and with the order count representing the upper limit count with which the commercial product can be ordered (S25).

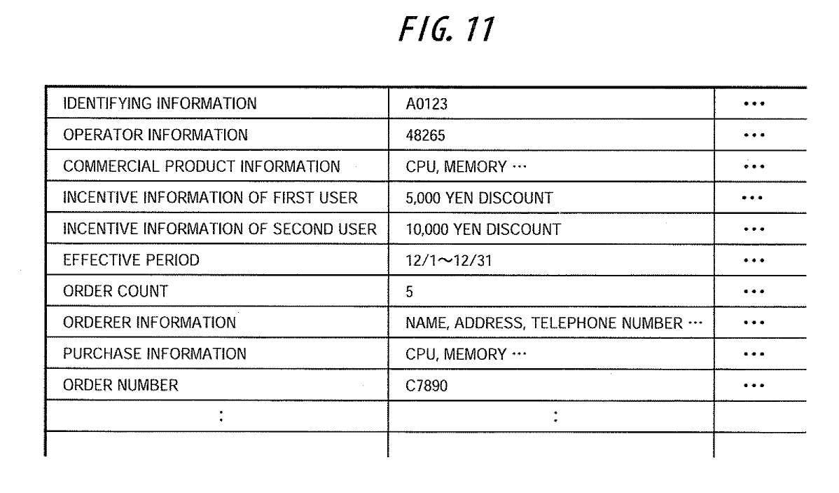

Then, the commercial product registration module 22 stores the storage unit 13 with the identifying information for identifying the information and the authentication key in the way of being associated with the commercial product information, the incentive information, the effective period and the order count (S26). FIG. 11 is an explanatory diagram of the information stored in the storage unit 13.

Further, the response module 23 transmits, as a result of the registration, the identifying information, the authentication key, the commercial product information, the incentive information, the effective period and the order count to the terminal 40 of the first user, and displays them (S27)

The first user notifies the second user of the identifying information and the authentication key by phone and by mail.

On the other hand, the second user notified of the identifying information, on the occasion of purchasing the commercial product, accesses the WEB shopping system 10 and transmits the authentication information (the identifying information and the authentication key) to the WEB shopping system 10 by operating the second user terminal 30. The WEB shopping system 10 receiving the authentication information refers to the information registered before hand and, if valid, authenticates the user (S31).

The WEB shopping system 10, if the user is authenticated, reads, from the storage unit 13, the commercial product, the incentive information, the effective period and the order count, which are associated with the identifying information in the authentication information, and transmits these items of information as a WEB page taking a predetermined format to the terminal 30 (S32). The WEB page is the same as in FIG. 4 and enables the parts and the options to be selected (modified) in the respective input boxes.

When the second user selects the order button on the page, the second user terminal 30 transmits, together with the information purporting the purchase, the identifying information and the commercial product information to the WEB shopping system 10 (S33). With these items of information, items of information necessary for the purchase such as a name and an address of the orderer and a payment method, may also be transmitted.

Then, the evaluation module 25 extracts the purchase information associated with the first user information on the first user basis, and evaluates each individual first user from the takings, the sales count, the commercial product information providing count, etc of the first user.

Thus, according to the second embodiment, the commercial product information can be properly managed, and it is therefore possible for the second user to easily invoke a first-user-suggested combination of commercial products on the basis of the identifying information.

Further, the first user can designate the incentive given to the second user. A ratio of the incentive of the first user to the incentive of the second-user can be thereby adjusted.

Moreover, the effective period can be set up, whereby the sense of purchase can be stimulated.

The infinite spread of the incentives can be prevented by setting up the effective count. Further, the sale count can also be managed.

What is claimed is:

1. A commercial product information management device comprising:
a commercial product input module receiving commercial product information inputted by an operation of a first user as a operator and first user information specifying the first user;
a commercial product registration module storing a storage unit with commercial product identifying information and incentive information in the way of being associated with the commercial product information and the first-user information; and
a response module transmitting, when receiving the identifying information on the occasion of a query from a second user, the associated commercial product information and the associated incentive information.

2. A commercial product information management device according to claim 1, wherein the commercial product registration module generates the incentive information of the first user and the incentive information of a second user, and gets these items of information stored.

3. A commercial product information management device according to claim 2, wherein the commercial product registration module, when the commercial product input module receives incentive designation information from the first user, generates the incentive information of the first user and the incentive information of the second user on the basis of the designation information.

4. A commercial product information management device according to claim 3, wherein the designation information is information for designating a ratio of the incentive information of the first user to the incentive information of the second user.

5. A commercial product information management method by which a computer executes:
receiving commercial product information inputted by an operation of a first user as an operator and first user information specifying the first user;
storing a storage unit with commercial product identifying information and incentive information in the way of being associated with the commercial product information and the first user information; and
transmitting, when receiving the identifying information on the occasion of a query from a second user, the associated commercial product information and the associated incentive information.

6. A commercial product information management method according to claim 5, wherein the incentive information of the first user and the incentive information of a second user are generated and stored.

7. A commercial product information management method according to claim 6, wherein when receiving incentive designation information from the first user, the incentive information of the first user and the incentive information of the second user are generated based on the designation information.

8. A commercial product information management method according to claim 7, wherein the designation information is information for designating a ratio of the incentive information of the first user to the incentive information of the second user.

9. A recording medium recorded with a commercial product information management program for making a computer execute:
receiving commercial product information inputted by an operation of a first user as an operator and first user information specifying the first user;
storing a storage unit with commercial product identifying information and incentive information in the way of being associated with the commercial product information and the first user information; and
transmitting, when receiving the identifying information on the occasion of a query from a second user, the associated commercial product information and the associated incentive information.

10. A recording medium according to claim 9, wherein the incentive information of the first user and the incentive information of a second user are generated and stored.

11. A recording medium according to claim 10, wherein when receiving incentive designation information from the first user, the incentive information of the first user and the incentive information of the second user are generated based on the designation information.

12. A recording medium according to claim 11, wherein the designation information is information for designating a ratio of the incentive information of the first user to the incentive information of the second user.
